(19) United States
(12) Patent Application Publication
(10) Pub. No.: US 2010/0100418 A1
(43) Pub. Date: Apr. 22, 2010

(54) ADAPTIVE SELF-LEARNING MARKETING AUTOMATION

(76) Inventors: J. Neal Richter, Belgrade, MT (US); Douglas K. Warner, Bozeman, MT (US); Stephen D. Durbin, Bozeman, MT (US); Anthony Arnone, Bozeman, MT (US)

Correspondence Address: HUSCH BLACKWELL SANDERS LLP, 4801 Main Street, Suite 1000, KANSAS CITY, MO, 64112, US

(21) Appl. No.: 12/254,555

(22) Filed: Oct. 20, 2008

(51) Int. Cl. G06Q 30/00

(52) U.S. Cl. 705/10; 705/14.55

(57) ABSTRACT

Systems and methods for monitoring and adapting marketing campaigns are described. Various aspects of the systems and methods include dynamically adjusting presented campaign frequency based upon measured success criteria, identifying important or superfluous portions of a campaign to adjust campaign sub-part frequency based upon measured success criteria, and/or recombining campaign sub-parts into entirely new campaigns and selecting for successful campaigns based upon measured success criteria.

### FIELD

This application relates generally to systems and methods for automated marketing and, more particularly, to automated marketing systems and methods that utilize adaptive self-learning to provide marketing information.

### BACKGROUND

Historically an entire suite of approaches have been used to contact potential customers, from various types of print advertising, to media advertising of all kinds (radio, TV, newspaper, etc), and even direct mail. The emergence of the Internet has provided an entirely new medium in which to market goods and services. With the Internet there are at least two additional channels of interest to marketers: email and web pages. New channels also emerge from this medium all the time, including chat, instant messaging, blogs, social networking applications, and numerous others. These additional channels have provided an opportunity for an entirely new class of approach to marketing. With the data for all aspects of a marketing campaign handled within a computer system, the opportunities for mass distribution and tracking are much greater than ever before. However, marketing remains much more of an art than a science.

The emergence of the internet as a marketing channel has spawned the emergence of a new class of systems for automating the marketing process. Marketing automation software has been produced to help manage outbound email campaigns as well as handle advertising on web pages, if not many other channels. Too often, however, these marketing automation systems simply replicate the same manual processes that the pre-computer marketer performed. Their automation primarily comes in the form of creating email distribution lists from a database of people and providing a workflow around the process of proofing and sending this email. Some more advanced marketing automation systems also track response rates to the campaigns.

### SUMMARY

Systems and methods for monitoring and adapting marketing campaigns are described. Various aspects of the inventive subject matter include dynamically adjusting presented campaign frequency based upon measured success criteria, identifying important or superfluous portions of a campaign to adjust campaign sub-part frequency based upon measured success criteria, and/or recombining campaign sub-parts into entirely new campaigns and selecting for successful campaigns based upon measured success criteria.

These and other advantageous features of the various embodiments will be in part apparent and in part pointed out herein below.

### BRIEF DESCRIPTION OF THE DRAWINGS

For a better understanding of the present invention, reference may be made to the accompanying drawings in which:

FIG. 1 is a flowchart illustrating a method for providing self-learning marketing campaigns according to embodiments of the invention;

FIG. 2 is a flowchart illustrating a method for providing self-learning marketing campaigns with adaptive segments according to embodiments of the invention;

FIG. 3 is a flowchart illustrating a method for providing self-learning marketing campaigns including identifying adaptive segments according to embodiments of the invention;

FIG. 4 is a flowchart illustrating a method for automatically generating self-learning marketing campaigns according to embodiments of the invention;

FIG. 5 is a flowchart illustrating a method for automatically generating self-learning marketing campaigns utilizing genetic algorithms according to embodiments of the invention;

FIG. 6 is a block diagram of data structures according to embodiments of the invention and used to provide campaign information, including priority information, in data storage; and

FIG. 7 is a block diagram of data structures according to embodiments of the invention and used to provide campaign information, including demographic priority information, in data storage.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the invention should correspond to the Fig. number in which the item or part is first identified.

The description of the various embodiments is to be construed as exemplary only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

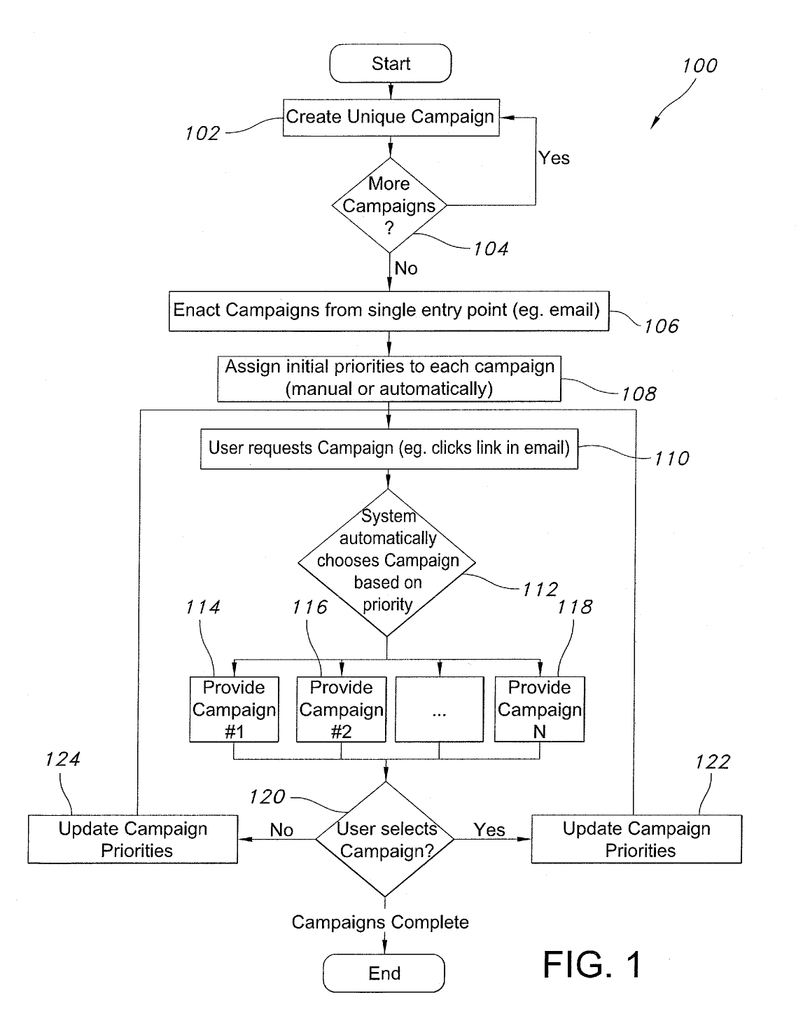

FIGS. 1-5 are flowcharts describing methods according to various embodiments. The methods may, in some embodiments, constitute computer programs made up of computer-executable instructions. Describing the methods by reference to a flowchart enables one skilled in the art to develop such programs including such instructions to carry out the method on suitable processors (the processor or processors of the computer executing the instructions from computer-readable media). The methods illustrated in FIGS. 1-5 are inclusive of acts that may be taken by an operating environment executing an exemplary embodiment of the invention.

For simplicity and illustrative purposes, the principles of the inventive subject matter are described by referring mainly to an example embodiment, with references to the Internet and the World Wide Web (WWW) as the example databases of informational items. However, one of ordinary skill in the art would readily recognize that the same principles are equally applicable to, and can be implemented in, other informational databases, and that such variations and modification are within the scope of the inventive subject matter. Similarly, references to an example embodiments including email could be readily recognized by one of ordinary skill in the art to be equally applicable to, and implemented in, other communication systems, such as targeted web pages, automated phone systems, interactive voice response systems (IVRs), and that any such variation would also not depart from the scope of the inventive subject matter.

In general, the embodiments described in detail below provide various forms of adaptive self-learning functionality to a marketing automation system. The marketing automation system may include methods to create a marketing campaign consisting of multiple sections (such as a product section and a discount section). In some embodiments, the campaign may be relayed to potential consumers via, for example, an email. A customer list to receive the email may be generated either manually or by some segmenting process, for example, a process using demographic or prior purchase information. Upon email receipt, the marketing automation system may track actions such as opening the email and click-through actions for web links (hyperlinks, URLs etc.) within the email. Similarly, the emails sent to potential consumers may include a method, for example via web links, to produce dynamic content. Finally, tracked actions as opened email and click-throughs, may be collected and summarized for reporting, logging or other purposes. The marketing automation system includes components and functionality sufficient to support the inventive aspects described herein to provide the adaptive self-learning functionality as described herein.

FIG. 1 is a flowchart illustrating a method for providing self-learning marketing campaigns according to embodiments of the invention. In general, the method provides the ability to adjust campaign delivery bias based upon campaign success criteria. In some embodiments this is accomplished by adding a success counter (or similar counter as would be evident to one of ordinary skill in the art) to each campaign and launching multiple campaigns to the same audience of potential consumers. Rather than have each individual receive each campaign, in some embodiments the campaigns are initially randomly assigned with equal likelihood. Upon each successful campaign interaction, the success counter for the campaign increases, thereby skewing the distribution for the remaining (unopened or unresponded) emails.

The method begins at block 102 with the creation of a campaign. The campaign may provide an offer to a consumer, such as a discount, buy one get one free, free shipping, or other inducement to persuade the consumer to buy a product or service. At block 104, a check is made to determine if further campaigns are to be created having alternative offers. If so, the method returns to block 102 to create another campaign for the product or service. If all desired campaigns have been created, the method proceeds to block 106, where the campaigns are enacted, that is, the campaigns are communicated to a desired target audience. In some embodiments, the campaigns may be enacted by sending an email to the members of the targeted group of consumers. In alternative embodiments, other communications mechanisms may be used, including chat, instant messaging, targeted web pages, automated phone systems, IVRs, etc.

At block 108, priorities may be assigned to each campaign. In some embodiments, each campaign may be assigned an equal priority such that each campaign has an equal likelihood of being selected. The priorities may be automatically assigned or they may be manually assigned. One of ordinary skill in the art can devise any number and variety of odds calculation formulae depending upon the desired characteristics of the system. Possible functions include linear, non-linear, step functions, fuzzy logic functions, or any number of other variants or combinations, for example also including any ceiling or floor limits, to the odds.

At block 110, a marketing automation system executing the method receives a request for a campaign. In some embodiments, the request may be received when a user utilizes a request mechanism such as a URL link and clicks the link in an email, instant message, responds to a phone prompt, etc. sent at block 106 (e.g., a click-through request).

At block 112, the marketing automation system then automatically selects a campaign 1 through N based on the currently assigned priorities for the campaigns associated with a product or service, where N is the number of campaigns created for a product or service. The selected campaign is then provided in response to the request at blocks 114-118. Blocks 114-118 are shown at the same level in the flowchart to reflect the fact that multiple campaigns sent to multiple potential consumers in a targeted audience may be simultaneously outstanding at any particular point in time. Thus one consumer may receive an offer of a discount for a product in a first campaign while another consumer may receive an offer of free shipping for the same product in a second campaign.

At block 120 the system determines if the user has selected a campaign provided at blocks 114-118. If the user selects a campaign, at block 122 the marketing automation system updates the priority for the selected campaign such that it is more likely the campaign will be provided when consumers in the target audience click-through an email. In some embodiments, if the user does not end up purchasing the product or service, then at block 124 the marketing automation system updates the priority for the selected campaign such that it is less likely the campaign will be provided when consumers click-through or otherwise respond to a campaign.

Those of ordinary skill in the art can see how this process could proceed linearly in real time as described, or in bulk fashion or asynchronously without disrupting the inventive process described herein.

The method then returns to block 110 to receive and process further requests for campaigns by consumers in the targeted audience.

### EXAMPLE 1

The following example will be used to illustrate the operation of the method described above. Assume that a marketer creates two campaigns (FIG. 1; 102, 104): (A) Purchase a widget at 10% off, and (B) Purchase a widget and get free shipping. The marketer then creates a population segment of 10 consumers to receive the campaigns. The marketer then creates an email template for the campaigns: “Hello, customer_first_name. Please Click Here to see our latest offers.” Finally, the marketer sends the campaign to the consumers (FIG. 1; 106).

The system responds by identifying there are two distinct campaigns sent to the consumers. It thus makes each campaign appear on the click-through with a 50% likelihood (i.e., the success counters on each campaign are set to the same value, for example 0) (FIG. 1; 108). If a consumer clicks through on the email (FIG. 1; 110-120) but does not make a purchase, there is no change (or a decrease) in the success counter (FIG. 1; 124). However, if the consumer clicks through and makes a purchase, the success counter is incremented (FIG. 1; 122). For the next consumer the presented campaign is now chosen based upon the resulting probability between the relative success rates of each offer. Table 1 below provides usage and offer statistics for the example:

TABLE 1

| | | | | | Randomly | |
|---|---|---|---|---|---|---|
| | Campaign A | | Campaign B | | Chosen | |
| User | Success/Odds | | Success/Odds | | Campaign | Purchase? |
| 1 | 0 | 50% | 0 | 50% | A | Y |
| 2 | 1 | 60% | 0 | 40% | A | Y |
| 3 | 2 | 75% | 0 | 25% | B | Y |
| 4 | 2 | 66% | 1 | 33% | B | Y |
| 5 | 2 | 50% | 2 | 50% | A | N |
| 6 | 2 | 50% | 2 | 50% | B | Y |
| 7 | 2 | 40% | 3 | 60% | B | Y |
| 8 | 2 | 20% | 4 | 80% | B | Y |
| 9 | 2 | 10% | 5 | 90% | A | N |
| 10 | 2 | 5% | 5 | 95% | B | Y |

Note in this example that the adjustment of the odds for selecting a campaign does not need to be based exclusively upon a linear calculation of the success counter. Similarly, a “lack of success” may also adjust the odds calculation. In the above example, campaign A was the only campaign that resulted in no purchase when offered. This “negative success” statistic can be used to bias the odds as well (as was done in the example).

While the example is presented with two campaigns, this choice is done for simplicity of explanation. Similarly, the number of consumers per campaign or segment has no limitation. The described approach will work for any number of campaigns or consumers.

To further explain Table 1, 10 e-mails were sent. The 1^{st} person (i.e., user) to respond to an e-mail, meaning that person clicked through a link in the e-mail, and was also the 1^{st} person to open the e-mail. The system randomly chose Campaign A for that first person, so the success odds are equal (50/50 odds). As shown, with the 2^{nd} person coming in, the odds are now 60/40 for Campaign A. Again, at this point, the system chooses Campaign A randomly with a bias towards Campaign A.

When the 3^{rd} person to click through, the odds are now shown as 75/25 for Campaign A, but the system randomly chose Campaign B at that point (just because it is a random coin toss). There is a slight chance of getting B and the system randomly chose B.

The 4^{th} person to click through, the odds are now 66/33 and again the system randomly chose the lower odds of B.

The 5^{th} person to click through, the odds are now 50/50 and the system randomly chose A again.

The 6^{th} person to click through, the odds are still 50/50 because there was no purchase so the system didn't adjust the odds.

The 7^{th} person to click through, the odds are now 40/60, so the system chooses Campaign B.

The 8^{th} person to click through, the odds are 20/80 and Campaign B is chosen.

The 9^{th} person to click through, the odds are 10/90 and the system chooses the lower one (Campaign A) again just because it's random.

The 10^{th} person to click through, the system is now biased so strongly in favor of Campaign B and it's very unlikely that anything besides Campaign B will be chosen into the future.

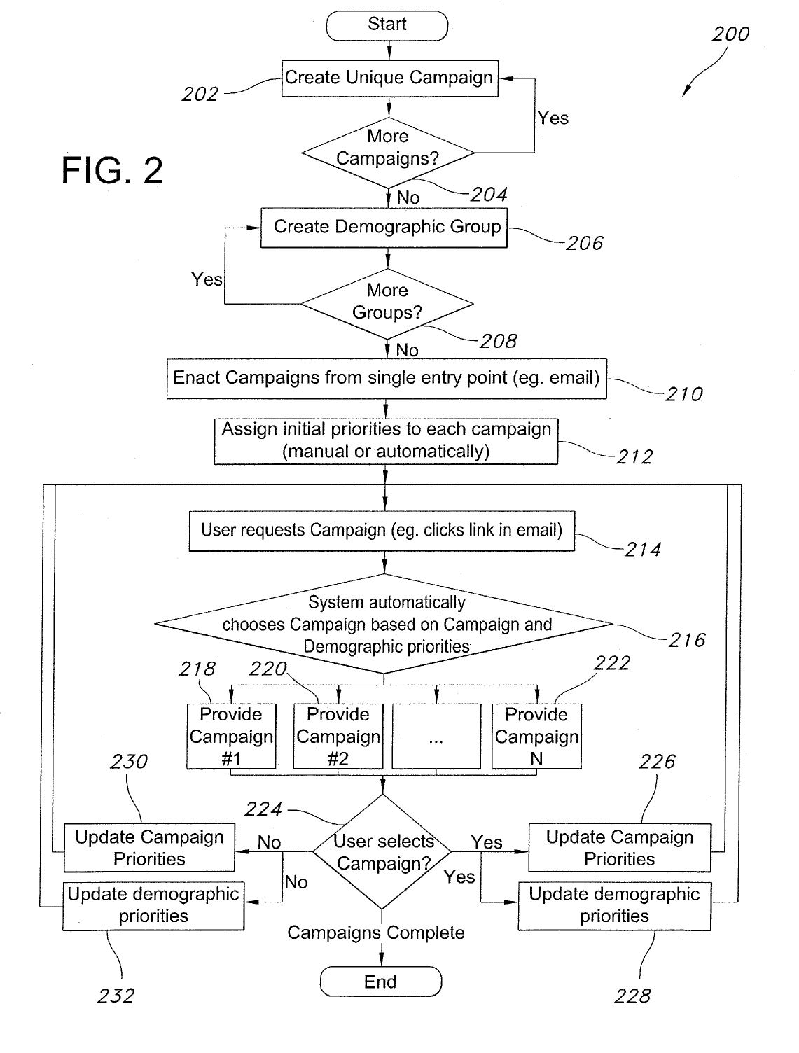

FIG. 2 is a flowchart illustrating a method for providing self-learning marketing campaigns with adaptive segments according to embodiments of the invention. In general, the method provides the ability for a marketing automation system to automatically adjust the campaigns by customer segment. These customer segments may be explicitly split during the marketer's definition of the campaign, or they may be deduced from data held within the system. In the first case where the marketer explicitly creates multiple segment groups with multiple campaigns, the system can extend the method illustrated above in FIG. 1 by adding a second set of success counters—not only is there a success criteria by campaign, there is a success criteria by customer segment. With this approach there now becomes a self-learning campaign distribution per segment.

The method begins at block 202 with the creation of a campaign. The campaign may provide an offer to a consumer, such as a discount, buy one get one free, free shipping, or other inducement to persuade the consumer to buy a product or service. At block 204, a check is made to determine if further campaigns are to be created having alternative offers. If so, the method returns to block 202 to create another campaign for the product or service.

When all desired campaigns have been created, the method proceeds to block 206 to create a demographic group. As noted above, the demographic group may be manually created, i.e. an administrator may define demographic groups within a target audience, or the demographic group may be automatically defined using data accessible to the marketing automation system. At block 208, a check is made to determine if further demographic groups are to be created. If so, the method returns to block 206 to create another demographic group. While FIG. 2 shows blocks 202, 204 occurring before blocks 206, 208, one of ordinary skill in the art can see these steps could occur in any order without disrupting the inventive process described herein.

After the desired campaigns and demographic groups have been created, the method proceeds to block 210 where the campaigns are enacted, that is, the campaigns are communicated to a desired target audience. In some embodiments, the campaigns may be enacted by sending an email to the members of the targeted group of consumers. In alternative embodiments, other communications mechanisms may be used, including chat, instant messaging, targeted web pages, automated phone systems, IVRs, etc.

At block 212, priorities may be assigned to each campaign. In some embodiments, each campaign may be assigned an equal priority such that each campaign has an equal likelihood of being selected. The priorities may be automatically assigned or they may be manually assigned. One of ordinary skill in the art can devise any number and variety of odds calculation formulae depending upon the desired characteristics of the system. Possible functions include linear, non-linear, step functions, fuzzy logic functions, or any number of other variants or combinations, for example also including any ceiling or floor limits to the odds.

At block 214, a marketing automation system executing the method receives a request for a campaign. In some embodiments, the request may be received when a user clicks a link in an email, instant message, responds to a prompt in an IVR, etc. sent at block 210 (e.g., a click-through request).

At block 216, the marketing automation system then automatically selects a campaign 1 through N. Here the selection is based on the currently assigned campaign priority and demographic priority associated with the campaign for a product or service, where N is the number of campaigns created for a product or service. The selected campaign is then provided in response to the request at blocks 218-222. Blocks 218-222 are shown at the same level in the flowchart to reflect the fact that multiple campaigns sent to multiple potential consumers in multiple demographic groups within a targeted audience may be simultaneously outstanding at any particular point in time. Thus one consumer in a first demographic group may receive an offer of a discount for a product in a first campaign while another consumer in a different demographic group may receive an offer of free shipping for the same product in a second campaign.

At block 224 the system determines if the user has selected a campaign provided at blocks 218-222. If the user selects a campaign, then at block 226 the marketing automation system updates the priority for the selected campaign. Further, at block 228, the demographic priority for the demographic group associated with the consumer is adjusted. The priority adjustments are such that it is more likely the campaign will be provided when consumers in the demographic group of the target audience click-through an email.

In some embodiments, if the user does not end up purchasing the product or service, then at block 230 the marketing automation system updates the priority for the selected campaign. Further, at block 232 the demographic priority for the demographic group is adjusted. The priorities are adjusted such that it is less likely the campaign will be provided when a consumer in the demographic group associated with the user click-through or otherwise respond to a campaign.

The method then returns to block 214 to receive and process further requests for campaigns by consumers in the targeted audience.

### EXAMPLE 2

This example extends the example provided above in Example 1 where there are two campaigns and 10 users. Assume that the 10 users are evenly (or even unequally) distributed into two segment groups, one male and one female (FIG. 2; 206, 208). With this example, the system maintains a success rate per gender per campaign, resulting in (after the system learns relative response rates (FIG. 2; 226, 228, 230, 232)), perhaps, males preferring campaign B while females prefer campaign A.

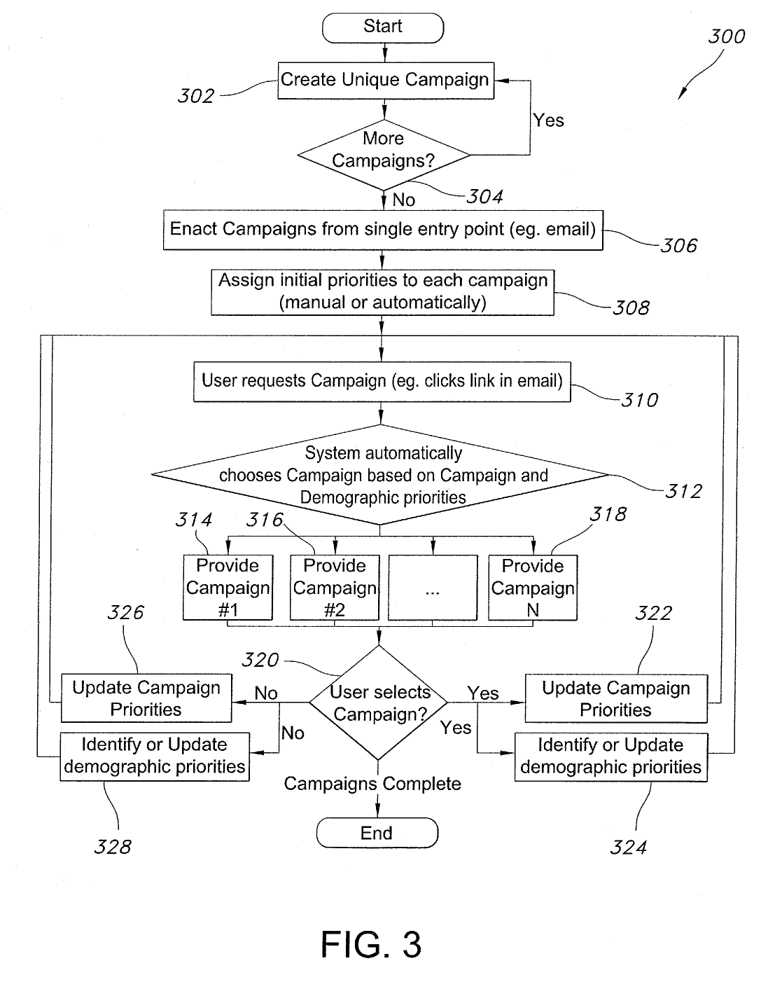

FIG. 3 is a flowchart illustrating a method for providing self-learning marketing campaigns including identifying adaptive segments according to embodiments of the invention. In general, the method provides the ability for a marketing automation system to recognize that a single segment has sub-groupings that respond distinctly to each campaign.

The method begins at block 302 with the creation of a campaign. The campaign may provide an offer to a consumer, such as a discount, buy one get one free, free shipping, or other inducement to persuade the consumer to buy a product or service. At block 304, a check is made to determine if further campaigns are to be created having alternative offers. If so, the method returns to block 302 to create another campaign for the product or service.

After the desired campaigns have been created, the method proceeds to block 306 where the campaigns are enacted, that is, the campaigns are communicated to a desired target audience. In some embodiments, the campaigns may be enacted by sending an email to the members of the targeted group of consumers. In alternative embodiments, other communications mechanisms may be used, including chat, instant messaging, targeted web pages, automated phone systems, IVRs, etc.

At block 308, initial priorities may be assigned to each campaign. In some embodiments, each campaign may be assigned an equal priority such that each campaign has an equal likelihood of being selected. The priorities may be automatically assigned or they may be manually assigned. One of ordinary skill in the art can devise any number and variety of odds calculation formulae depending upon the desired characteristics of the system. Possible functions include linear, non-linear, step functions, fuzzy logic functions, or any number of other variants or combinations, for example also including any ceiling or floor limits, to the odds.

At block 310, a marketing automation system executing the method receives a request for a campaign. In some embodiments, the request may be received when a user clicks a link in an email, instant message, responds to a prompt in an IVR, etc. sent at block 306 (e.g., a click-through request).

At block 312, the marketing automation system then automatically selects a campaign 1 through N. Here the selection is based on the currently assigned campaign priority and demographic priority associated with the campaign for a product or service, where N is the number of campaigns created for a product or service. The selected campaign is then provided in response to the request at blocks 314-318. Blocks 314-318 are shown at the same level in the flowchart to reflect the fact that multiple campaigns sent to multiple potential consumers in a targeted audience may be simultaneously outstanding at any particular point in time.

At block 320 the system determines if the user has selected a campaign provided at blocks 314-318. If the user selects a campaign, then at block 322 the marketing automation system updates the priority for the selected campaign. Further, at block 324, the system identifies a demographic group associated with the user. If a new demographic group is identified, it is associated with the consumer. Otherwise, a previously identified demographic group may be updated. A demographic priority for the demographic group associated with the consumer is adjusted. The priority adjustments are such that it is more likely the campaign will be provided when consumers in the demographic group of the target audience click-through an email.

In some embodiments, if the user does not end up purchasing the product or service, then at block 326 the marketing automation system updates the priority for the selected campaign. Further, at block 328, the system identifies a demographic group associated with the user. If a new demographic group is identified, it is associated with the consumer. Otherwise, a previously identified demographic group may be updated. The priorities for the demographic group are adjusted such that it is less likely the campaign will be provided when a consumer in the demographic group associated with the user click-through or otherwise respond to a campaign.

The method then returns to block 310 to receive and process further requests for campaigns by consumers in the targeted audience and to identify or update further demographic groups and demographic priorities based on responses to campaigns.

Those of ordinary skill in the art can see how this process could proceed linearly in real time as described, or in bulk fashion or asynchronously without disrupting the inventive process described herein.

It should be noted that demographic groups may be identified at points other than blocks 324 and 328. For example, the marketing automation system may periodically analyze the data and apply various statistical techniques (such as regression, factor analysis, clustering, and the like), artificial intelligence techniques (neural networks, expert systems, fuzzy logic, swarm intelligence, genetic algorithms, and the like), or other of a number of alternate approaches to identify demographic groups.

### EXAMPLE 3

This example again assumes the group provided in Example 1. Here assume there is a campaign A and campaign B and a single segment of 10 people (FIG. 3; 302-308). Either with each incoming click-through, or with periodically analyzing a group of data, the system keeps track of a response rate for each demographic or data characteristic stored in the system (FIG. 3; 322, 324, 326, 328). Leading trends are then used either individually or in combination to bias the campaign presentation based upon identified characteristics of the individual. While this example includes only one demographic segment and two campaigns, there are no implied limitations in this approach—any number of demographic segments and any number of campaigns are acceptable under this approach.

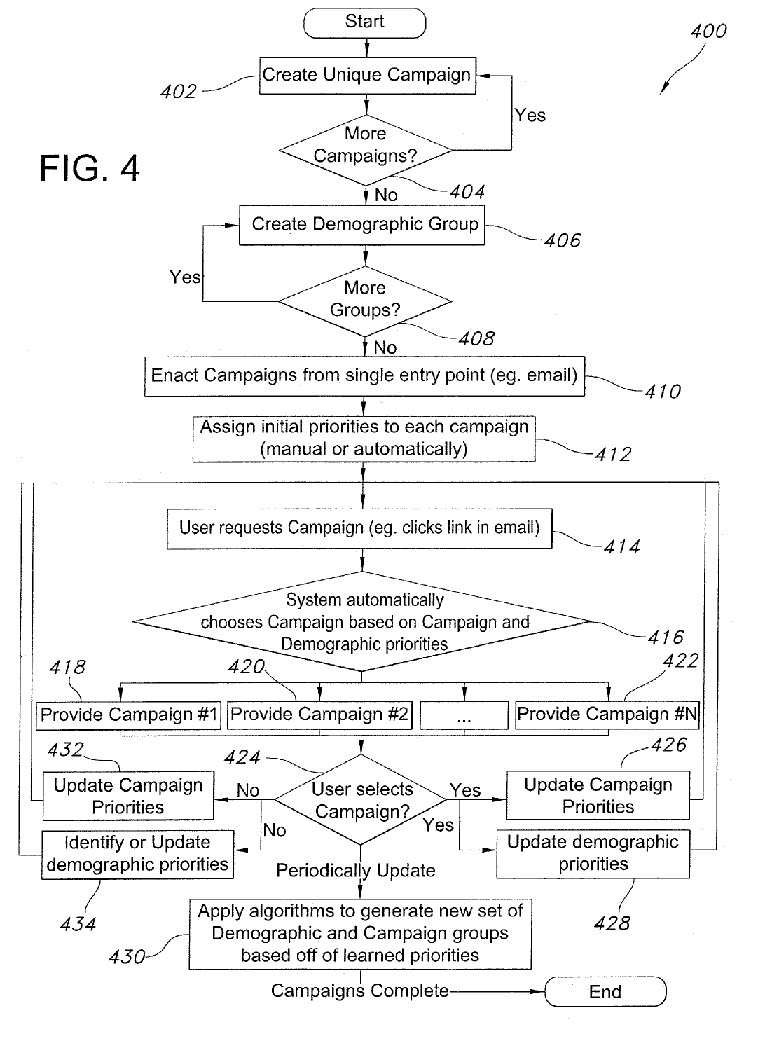

FIG. 4 is a flowchart illustrating a method for automatically generating self-learning marketing campaigns according to embodiments of the invention. In general, the method provides a way to automatically generate adaptive campaigns. In this approach, the marketer generates a set of campaigns and segments with various attributes and the system determines which segment and attribute pairings produce the greatest acceptance rate.

The method begins at block 402 with the creation of a campaign. The campaign may provide an offer to a consumer, such as a discount, buy one get one free, free shipping, or other inducement to persuade the consumer to buy a product or service. At block 404, a check is made to determine if further campaigns are to be created having alternative offers. If so, the method returns to block 402 to create another campaign for the product or service.

When all desired campaigns have been created, the method proceeds to block 406 to create a demographic group. As noted above, the demographic group may be manually created, i.e. an administrator may define demographic groups within a target audience, or the demographic group may be automatically defined using data accessible to the marketing automation system. At block 408, a check is made to determine if further demographic groups are to be created. If so, the method returns to block 406 to create another demographic group.

After the desired campaigns and demographic groups have been created, the method proceeds to block 410 where the campaigns are enacted, that is, the campaigns are communicated to a desired target audience. In some embodiments, the campaigns may be enacted by sending an email to the members of the targeted group of consumers. In alternative embodiments, other communications mechanisms may be used, including chat, instant messaging, targeted web pages, automated phone systems, IVRs, etc.

At block 412, priorities may be assigned to each campaign. In some embodiments, each campaign may be assigned an equal priority such that each campaign has an equal likelihood of being selected. The priorities may be automatically assigned or they may be manually assigned. One of ordinary skill in the art can devise any number and variety of odds calculation formulae depending upon the desired characteristics of the system. Possible functions include linear, non-linear, step functions, fuzzy logic functions, or any number of other variants or combinations, for example also including any ceiling or floor limits, to the odds. While FIG. 4 shows blocks 402, 404 occurring before blocks 406, 408, one of ordinary skill in the art can see that these steps could occur in any order without disrupting the inventive process described herein.

At block 414, a marketing automation system executing the method receives a request for a campaign. In some embodiments, the request may be received when a user clicks a link in an email, instant message, responds to a phone prompt, etc. sent at block 410 (e.g., a click-through request).

At block 416, the marketing automation system then automatically selects a campaign 1 through N. Here the selection is based on the currently assigned campaign priority and demographic priority associated with the campaign for a product or service, where N is the number of campaigns created for a product or service. The selected campaign is then provided in response to the request at blocks 418-422. Blocks 418-422 are shown at the same level in the flowchart to reflect the fact that multiple campaigns sent to multiple potential consumers in multiple demographic groups within a targeted audience may be simultaneously outstanding at any particular point in time. Thus one consumer in a first demographic group may receive an offer of a discount for a product in a first campaign while another consumer in a different demographic group may receive an offer of free shipping for the same product in a second campaign.

At block 424 the system determines if the user has selected a campaign provided at blocks 418-222. If the user selects a campaign, then at block 426 the marketing automation system updates the priority for the selected campaign. Further, at block 428, the demographic priority for the demographic group associated with the consumer is adjusted. The priority adjustments are such that it is more likely the campaign will be provided when consumers in the demographic group of the target audience click-through an email.

In some embodiments, if the user does not end up purchasing the product or service, then at block 432 the marketing automation system updates the priority for the selected campaign. Further, at block 434 the demographic priority for the demographic group is adjusted. The priorities are adjusted such that it is less likely the campaign will be provided when a consumer in the demographic group associated with the user click-through or otherwise respond to a campaign.

In addition, at various points in time (e.g., at periodic intervals), at block 430 the marketing automation system analyzes the data to determine if there are new demographic groups or whether a new campaign should be created. For example, the system may use iterative learning to determine that a new campaign may be desirable. The new campaign may be added and provided in response to a click-through. The analysis may also determine that some campaigns are not effective and should not be provided.

The method then returns to block 414 to receive and process further requests for campaigns by consumers in the targeted audience.

### EXAMPLE 4

The following example is provided to illustrate the method described above in FIG. 4. Given the complexity of data combinations and iterations that would be required to correctly represent the functionality of the automatically generated campaigns, this example will be significantly scaled back to avoid obscuring the inventive subject matter. In this example, consider two distinct population groupings: Gender, and residence in California or Montana. Also consider two distinct campaigns: free vs. reduced cost shipping, and 10% vs. 15% discount. A marketer might choose to construct the following offers: Males in California get free shipping and a 10% discount, while Females in Montana get reduced cost shipping and a 15% discount (FIG. 4; 402-408). One of ordinary skill in the art should see 16 possible combinations of the described occurrences. Not all of these combinations need to be described or used by the system. After a series of iterative learning (FIG. 4; 414-434) the system may identify a suite of more successful campaigns which might include: Males in Montana get a 15% discount, Females in California get discounted shipping and 10% off, and Females in Montana get free shipping and a 15% discount, and Males in California get free shipping and a 10% discount. Thus, the system has determined a different set of items than the marketer initially identified from the possible combinations of campaign elements.

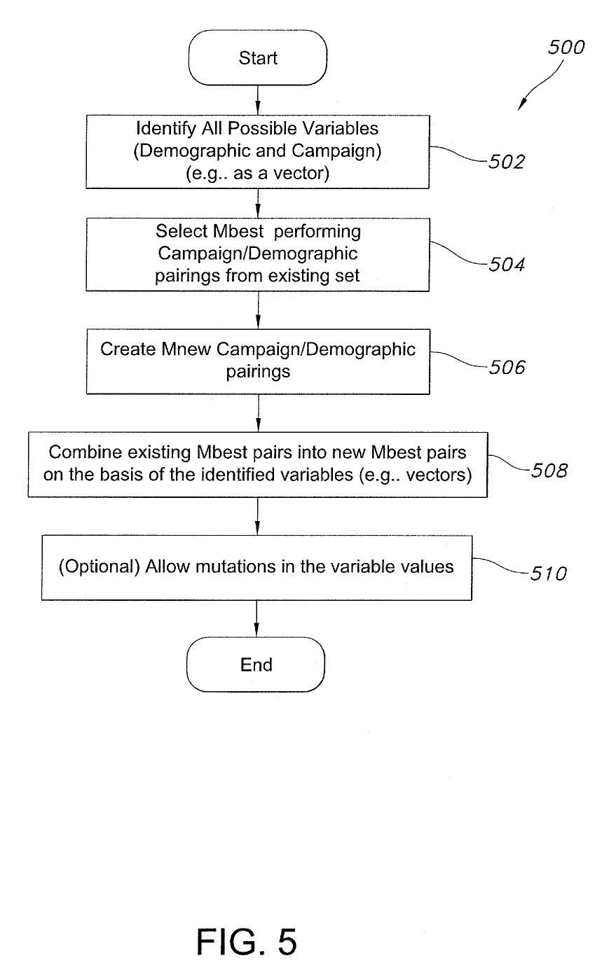

Note in this symbolic example that the number of resulting offers may be greater or less than that originally offered by the marketer. Also, the attributes defining an offer may be greater or less than the marketer specified (i.e., all males, independent of residential state, or only one of the two available discounts). Finally, the original marketer specified offers may carry through the system as effective or may be supplanted by alternate offers created by the system. In order to avoid obscuring the inventive subject matter, steps to collect feedback on each offer and to cross-breed the offers have been left out of the example. These steps are within the ability of one of ordinary skill in the art of genetic algorithms, and represented simplistically in FIG. 4 item 430 and FIG. 5 in its entirety.

FIG. 5 is a flowchart illustrating a method for automatically generating self-learning marketing campaigns utilizing genetic algorithms according to embodiments of the invention. The method begins at block 502 by identifying possible variables within data accessible to a marketing automation system that may be used to identify demographic groups and/or campaign data. The identified variables are attributes of a campaign and segment and correspond to heritable attributes of the campaign or segment. In some embodiments, the identified variables may be expressed as a data vector similar to a DNA sequence. The initial vector is used as a starting point in the feedback process illustrated above in FIGS. 1-4.

At block 504, the system selects the M best performing campaign and demographic pairings from the current data set, where M is the number of desired pairings. The “best” pairings may be determined using an evaluation function such as, but not limited to, the success rate for the pairing.

At block 506, the system creates M new campaign and demographic pairings from the existing data.

At block 508 the system combines the existing M best pairings with the newly created pairings to create a new set of M best pairings on the basis of the identified variables and attributes. The combination may be performed using any of a variety of cross-breeding techniques typically used in genetic algorithms. The results of the cross-breeding can (and, in fact is expected to) result in a unique combination of customer segment attributes and campaign attributes. Upon multiple iterations of the cross-breeding operation the resulting segments and campaigns will represent the best possible combination of attributes to produce a highly effective campaign or set of campaigns, without requiring the marketer to have any prior expectation of the value of that combination.

In some embodiments, mutations of the variable values may be used as part of the process in order to obtain potential new best pairings. Methods of providing mutations may be any of those typically used in genetic algorithms.

Further details on the genetic algorithms that may be used in some embodiments may be found in the document entitled “A Genetic Algorithm Tutorial” available at the URL “www.cs.iastate.edu/˜honavar/ga_tutorial.pdf”, which is hereby incorporated by reference.

While some embodiments use genetic algorithms to produce the desired effect, one of ordinary skill in the art can easily see how any number of algorithms could be used to extract and recombine attributes of segments and campaigns in various ways, from statistical to artificial intelligence approaches.

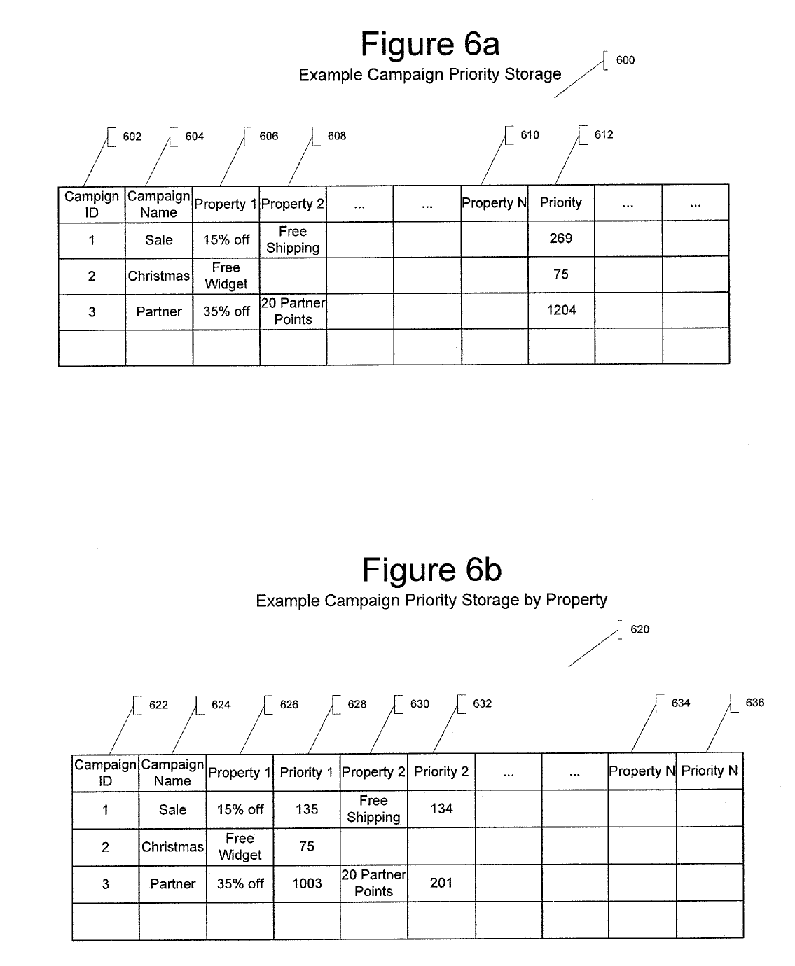

FIGS. 6A and 6B are block diagrams of data structures according to embodiments of the invention and used to provide campaign information, including priority information, in data storage. One of ordinary skill in the art may identify legion alternate methods of storage, however, the examples provided are educational in their descriptive simplicity. FIG. 6A describes a simple storage mechanism that would represent the data used in the method described above with reference to FIG. 1 and Example 1. FIG. 6B describes a slightly altered version that would represent the additional data available and used by the method described above in FIG. 2 and Example 2.

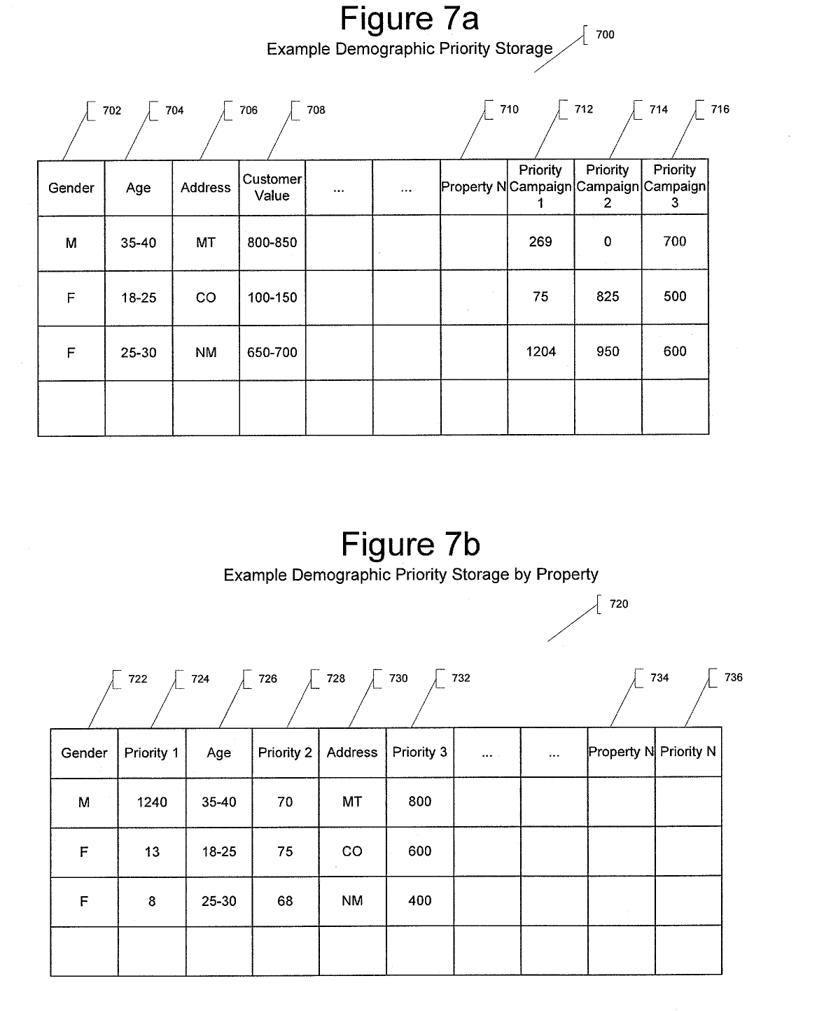

FIGS. 7A and 7B are block diagrams of data structures according to embodiments of the invention and used to provide campaign information, including demographic priority information, in data storage. FIG. 7A describes a simple storage mechanism for storing ratings for demographic information for each campaign, as may be used in the method described above with reference to FIG. 3 and Example 3. FIG. 7B shows how this might differ if there were one demographic table per campaign, with priority data collected per demographic feature, as might be done in the methods illustrated in FIG. 3 or FIG. 4 and in Example 3 or Example 4. Similar to FIG. 6, these examples are but one approach of may obvious to the one of ordinary skill in the art, but chosen for their descriptive simplicity.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. § 1.72(b) to allow the reader to quickly ascertain the nature and gist of the technical disclosure. The Abstract is submitted with the understanding that it will not be used to limit the scope of the claims.

What is claimed is:

1. A method comprising:
creating a plurality of marketing campaigns, the marketing campaigns each having an offer;
assigning a campaign priority to each of the plurality of marketing campaigns;
providing a communication to a plurality of potential consumers, the communication including a request mechanism;
receiving a request from a potential consumer of the plurality of potential consumers;
in response to the request, selecting one of the plurality of marketing campaigns in accordance with the campaign priorities of the plurality of marketing campaigns and providing the selected marketing campaign to the potential consumer;
receiving an indication the potential consumer has responded to the offer in the selected marketing campaign; and
updating the campaign priority of the selected marketing campaign in accordance with the response to the offer.

2. The method of claim 1, wherein the communication comprises one of an email, a phone system, an interactive voice response system, a targeted web page, and a chat.

3. The method of claim 1, wherein providing the selected marketing campaign comprises providing at least one of a web page including the offer, a phone system over which the offer is included, and a chat wherein the offer is provided.

4. The method of claim 3, wherein the web page is dynamically created.

5. The method of claim 1, wherein the response to the offer is a positive response to the offer and wherein the campaign priority of the campaign associated with the offer is adjusted such that it is more likely that the campaign is selected to be presented.

6. The method of claim 1, wherein the response to the offer is a negative response to the offer and wherein the priority of the campaign associated with the offer is adjusted such that it is less likely that the campaign is selected to be presented.

7. The method of claim 1, further comprising:
determining a plurality of demographic groups within the plurality of potential consumers; and
assigning a demographic priority for each of the plurality of demographic groups;
wherein selecting a campaign includes selecting a campaign in accordance with the campaign priorities and the demographic priorities, and
wherein the demographic priority is adjusted in accordance with the response to the offer.

8. The method of claim 7, wherein determining the plurality of demographic groups includes automatically identifying one or more demographic groups within the plurality of potential consumers.

9. The method of claim 8, wherein automatically identifying one or more demographic groups includes applying statistical analysis to data associated with the plurality of potential consumers.

10. The method of claim 9, wherein the statistical analysis include regression analysis, factor analysis or clustering.

11. The method of claim 8, wherein automatically identifying one or more demographic groups includes applying artificial intelligence techniques to data associated with the plurality of consumers.

12. The method of claim 11, wherein the artificial intelligence techniques include neural networks, expert systems, fuzzy logic, swarm intelligence or genetic algorithms.

13. The method of claim 7, and further comprising:
analyzing data associated with the plurality of campaigns; and
adding one or more new campaigns to the plurality of campaigns or removing one or more campaigns from the plurality of campaigns in accordance with the analysis.

14. The method of claim 13, wherein analyzing the data includes applying a genetic algorithm to analyze the data.

15. The method of claim 14, wherein the applying the genetic algorithm includes:
identifying campaign attributes of the plurality of campaigns and demographic attributes of the plurality of demographic groups;
creating a plurality of best pairings using the campaign attributes and the demographic attributes;
creating a plurality of new pairings using the campaign attributes and the demographic attributes; and
combining the best pairings and the new pairings to determine a new set of best pairings.

16. The method of claim 15, and further comprising mutating the attributes values of the plurality of best pairings.

17. A computer-readable medium having computer-executable instructions that when executed, causes one or more processors to perform a method, the method comprising:
creating a plurality of marketing campaigns, the marketing campaigns each having an offer;
assigning a campaign priority to each of the plurality of marketing campaigns;
providing a communication to a plurality of potential consumers, the communication including a request mechanism;
receiving a request from a potential consumer of the plurality of potential consumers;
in response to the request, selecting one of the plurality of marketing campaigns in accordance with the campaign priorities of the plurality of marketing campaigns and providing the selected marketing campaign to the potential consumer;
receiving an indication the potential consumer has responded to the offer in the selected marketing campaign; and
updating the campaign priority of the selected marketing campaign in accordance with the response to the offer.

18. The computer-readable medium of claim 17, wherein the communication comprises one of an email, a phone system, an interactive voice response system, a targeted web page, and a chat.

19. The computer-readable medium of claim 17, wherein the response to the offer is a positive response to the offer and wherein the campaign priority of the campaign associated with the offer is adjusted such that it is more likely that the campaign is selected to be presented.

20. The computer-readable medium of claim 17, wherein the method further comprises:
determining a plurality of demographic groups within the plurality of potential consumers; and
assigning a demographic priority for each of the plurality of demographic groups;
wherein selecting a campaign includes selecting a campaign in accordance with the campaign priorities and the demographic priorities, and
wherein the demographic priority is adjusted in accordance with the response to the offer.

21. The computer-readable medium of claim 20, wherein determining the plurality of demographic groups includes automatically identifying one or more demographic groups within the plurality of potential consumers.

22. The computer-readable medium of claim 17, and further comprising:
analyzing data associated with the plurality of campaigns; and
adding one or more new campaigns to the plurality of campaigns or removing one or more campaigns from the plurality of campaigns in accordance with the analysis of the data.

23. The computer-readable medium of claim 22, wherein analyzing the data includes applying a genetic algorithm to analyze the data.

24. The computer-readable medium of claim 23, wherein the applying the genetic algorithm includes:
identifying campaign attributes of the plurality of campaigns and demographic attributes of the plurality of demographic groups;
creating a plurality of best pairings using the campaign attributes and the demographic attributes;
creating a plurality of new pairings using the campaign attributes and the demographic attributes; and
combining the best pairings and the new pairings to determine a new set of best pairings.

25. A system comprising:
means for creating a plurality of marketing campaigns, the marketing campaigns each having an offer;
means for assigning a campaign priority to each of the plurality of marketing campaigns;
means for providing a communication to a plurality of potential consumers, the communication including a request mechanism;
means for receiving a request from a potential consumer of the plurality of potential consumers;
in response to the request, means for selecting one of the plurality of marketing campaigns in accordance with the campaign priorities of the plurality of marketing campaigns and providing the selected marketing campaign to the potential consumer;
means for receiving an indication the potential consumer has responded to the offer in the selected marketing campaign; and
means for updating the campaign priority of the selected marketing campaign in accordance with the response to the offer.
